(19) United States
(12) Patent Application Publication
(10) Pub. No.: US 2011/0215902 A1
(43) Pub. Date: Sep. 8, 2011

(54) CUSTOMER RECOGNITION METHOD AND SYSTEM

(76) Inventors: Carl E. Brown, III, Silver Spring, MD (US); Klaus Peters, Miami Beach, FL (US); Arthur A. Russell, Largo, MD (US); Gerard M. Folly, Silver Spring, MD (US); Daniel Turissini, Mclean, VA (US)

(21) Appl. No.: 13/040,006

(22) Filed: Mar. 3, 2011

Related U.S. Application Data
(60) Provisional application No. 61/310,162, filed on Mar. 3, 2010.

(51) Int. Cl. G06F 7/04

(52) U.S. Cl. 340/5.81

(57) ABSTRACT

Disclosed embodiments describe a customer recognition method and system. The customer recognition system has an acknowledgment server that carries out the customer recognition method. The customer recognition method may include storing customer profile data related to a customer and identity device data related to an identity device; receiving a unique device identifier from a sensor within communication range of the identity device; retrieving customer profile data from the profile database based on the received identifier; sending the customer profile data to the sensor; and receiving an acknowledgement status relating to the customer.

This application claims priority to provisional application No. 61/310,162, filed on Mar. 3, 2010, which is hereby incorporated by reference in its entirety.

### FIELD OF THE INVENTION

Embodiments of the invention relate generally to the communications field and more particularly, to a method and system for customer recognition using a personal communications device.

### BACKGROUND

Conventional communications systems provide a mechanism to exchange information between communications devices. Examples of such systems include the radio waves in smart cards embedded with radio-frequency identification (RFID) tags similar to those used in the electronic toll road systems. The RFID tag contains identifying information that can be read by an RFID reader using radio waves. More recently, the Bluetooth, WIFI and Broadband communications protocols have been used to connect and exchange information between compatible devices such as cellular telephones, personal digital assistants (PDA), smart phones, laptops and digital cameras.

Businesses use a variety of methods and systems for personnel accountability and customer identification. For example, factory workers, dock workers and staff/visitors at secured facilities are required to carry identification cards or tokens to swipe in/out when entering and exiting or changing shifts. Conventional recognition systems include the use of pre-issued photo identification badges and identification cards embedded with RFID tags containing identifying information that can be read by an RFID reader using radio waves. These conventional recognition systems require repetitive data entry and are less automated than desired. Existing systems also suffer from having to issue cards and tokens to each registered person. These systems are even less desirable when used to identify customers.

Accordingly, there is a need and desire for an improved mechanism for recognizing a customer using standard communications protocols over public communications channels without the need for separately issued identification cards and tokens.

### BRIEF DESCRIPTION OF THE DRAWINGS

The foregoing and other advantages will become more apparent from the detailed description of exemplary embodiments provided below with reference to the accompanying drawings in which:

FIG. 1 is a block diagram overview of a system in accordance with an example embodiment described herein;

FIG. 2 is a block diagram of a virtual customer acknowledgment system server in accordance with an example embodiment described herein.

FIG. 3 is a diagram illustrating a layout of local sensors in a facility in accordance with an example embodiment described herein;

FIG. 4 is a flowchart of a method for customer recognition in accordance with an example embodiment described herein;

FIG. 5 is a flowchart of an identity device activation method in accordance with an example embodiment described herein;

FIG. 6A is a diagram of a split display screen for a customer recognition output device in accordance with an example embodiment described herein; and

FIG. 6B is another diagram of a split display screen for a customer recognition output device in accordance with an example embodiment described herein.

### DETAILED DESCRIPTION OF THE INVENTION

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural and logical changes may be made. Sequences of steps are not limited to those set forth herein and may be changed or reordered, with the exception of steps necessarily occurring in a certain order.

The problem of customer recognition without the need for separately issued identification cards and tokens is solved by leveraging communications devices that use standard communications protocols over public communications channels. Disclosed embodiments provide a computer-based system and method for customer recognition.

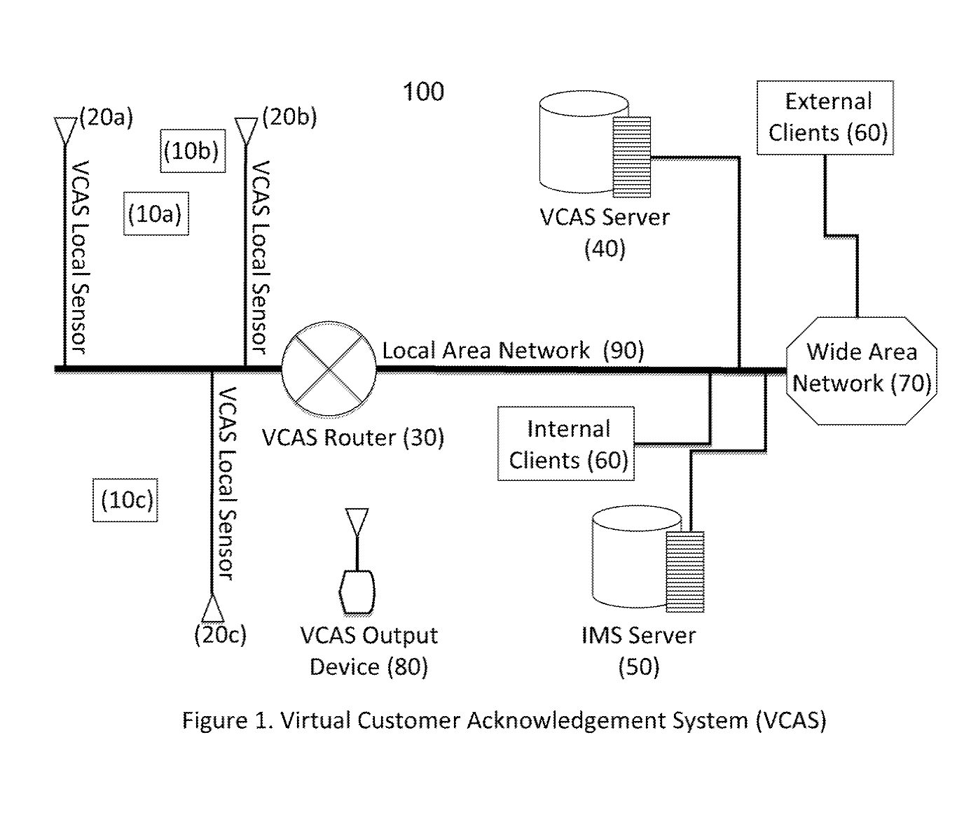

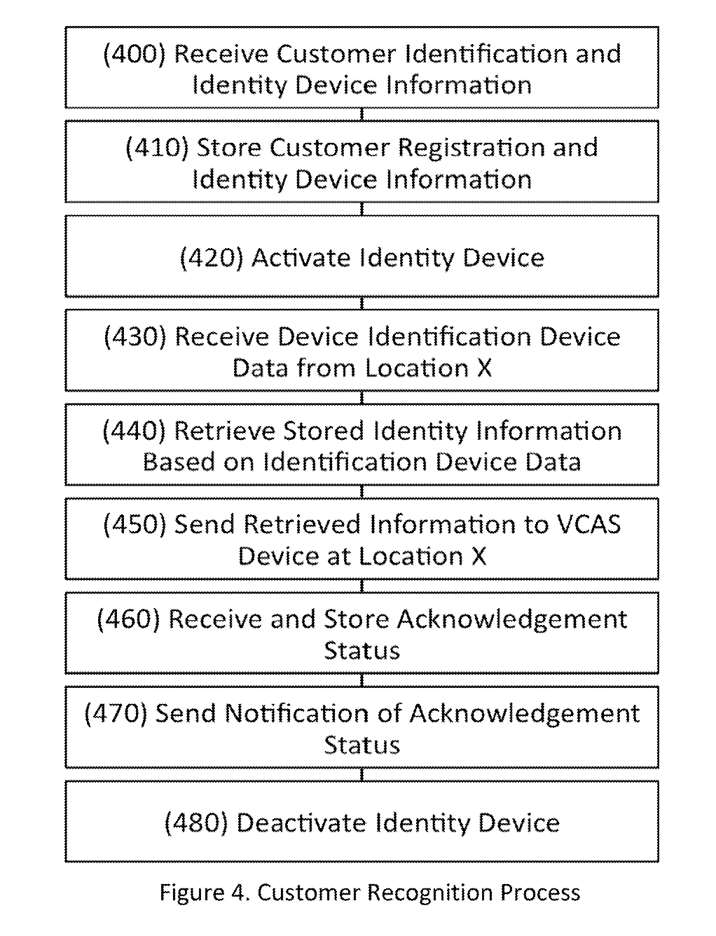

FIGS. 1 and 4 respectively show a customer recognition system 100 and method according to an example embodiment. The disclosed embodiments may be advantageously used in any customer services industry, e.g., facilities, retails, airports, country clubs, etc. Therefore, in the following example embodiment, the system 100 is described as being implemented in a framework for a customer management system. It will be appreciated that those skilled in the art will be able to incorporate the disclosed embodiments into numerous alternative systems and environments and can be used for customer recognition during facility visits, airline/cruiseship boarding, retail shopping, the accounting of factory, dock or other workers changing shifts, identification of staff and visitors at secured facilities to name a few. A particular system implementation, while not shown or described herein, embodies the principles disclosed herein. Thus, the disclosed embodiments are not limited to any single customer services environment. Moreover, although reference is made to “customers,” it should be appreciated that the identification of customers, visitors, employees, etc. is within the scope of the embodiments.

The system 100 is managed by the facility management and comprises a virtual customer acknowledgment system (VCAS) server 40 in communication with an existing Information Management System (IMS) server 50 (or similar entity server) over a local area network (LAN) 90. The LAN 90 is preferably a combination of secured hard-wired and wireless network infrastructure, preferably using the Internet routing and transmission protocol (TCP/IP). The LAN 90 facilitates communication between the VCAS server 40 and the IMS server 50 and provides direct access to a Wide Area Network 70, including Internet, telecom and/or broadband, as shown in FIG. 1.

The LAN 90 also securely connects a VCAS router 30 to the VCAS server 40 and the IMS server 50. The VCAS router 30 communicates with VCAS local sensors, e.g., sensor 20a, 20b and 20c (collectively “local sensors 20”) via the LAN 90. The local sensors 20 are capable of receiving data from and sending data to a personal identity device (e.g., cellular telephone 10a, smart phone 10b and Blackberry™ 10c (collectively “identity devices 10”)) and a VCAS output device 80, e.g., PDA and laptop. In the system 100, the local sensors 20 are Bluetooth, WIFI, or Broadband enabled routers, and the identity devices 10 and VCAS output devices 80 are Bluetooth, WIFI, or Broadband enabled devices that can form a trusted pairing with the sensors 20. Once the enabled identity devices 10 and sensors 20 are paired with each other, the identity devices 10 and sensors 20 can communicate with each other when they are within communication range. The pairing process is discussed in more detail below in connection with the customer recognition process of FIG. 4. It will be appreciated that those skilled in the art will be able to devise alternative embodiments using other standards based communications protocols, e.g., digital mobile communication or wideband mobile communication, for enabling the identity devices 10 to communicate with the local sensors 20.

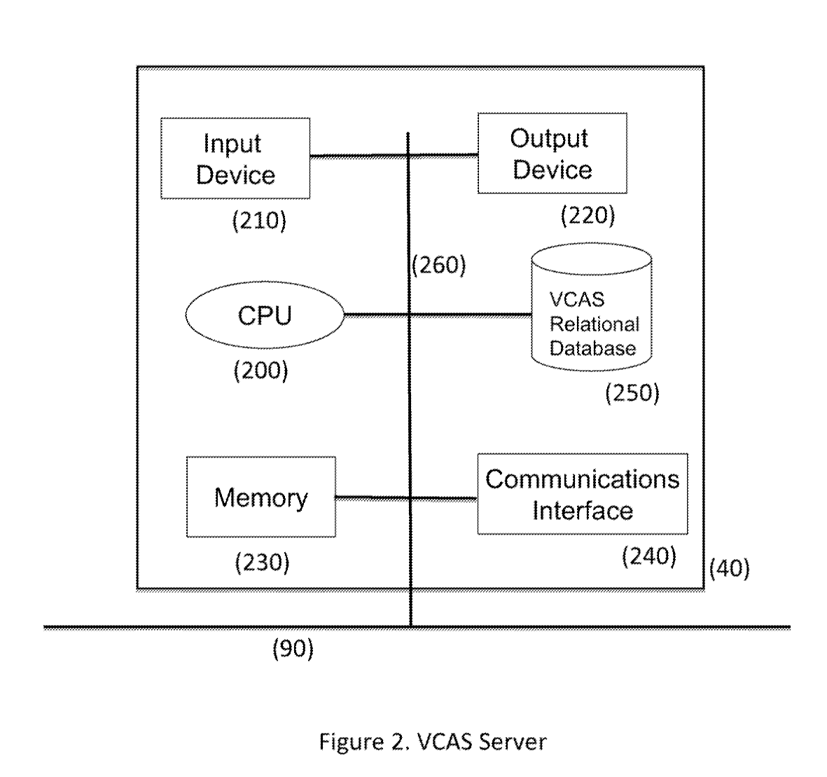

FIG. 2 is a block diagram of the VCAS server 40 in accordance with an embodiment described herein. The VCAS server 40 includes: a bus 260 for facilitating communication between at least a central processing unit (CPU) 200 used for carrying out the customer recognition process; an input device 210 used for accepting instructions from an operator; an output device 220 (i.e., display) used for displaying information to the operator; memory 230 for storing software code implementing the customer recognition process (described below); a communications interface 240 used for facilitating the transfer of data over the LAN 90; and a VCAS relational database 250 used for storing customer information. In a desired embodiment, customer information is stored securely in an encrypted form in the VCAS relational database 250.

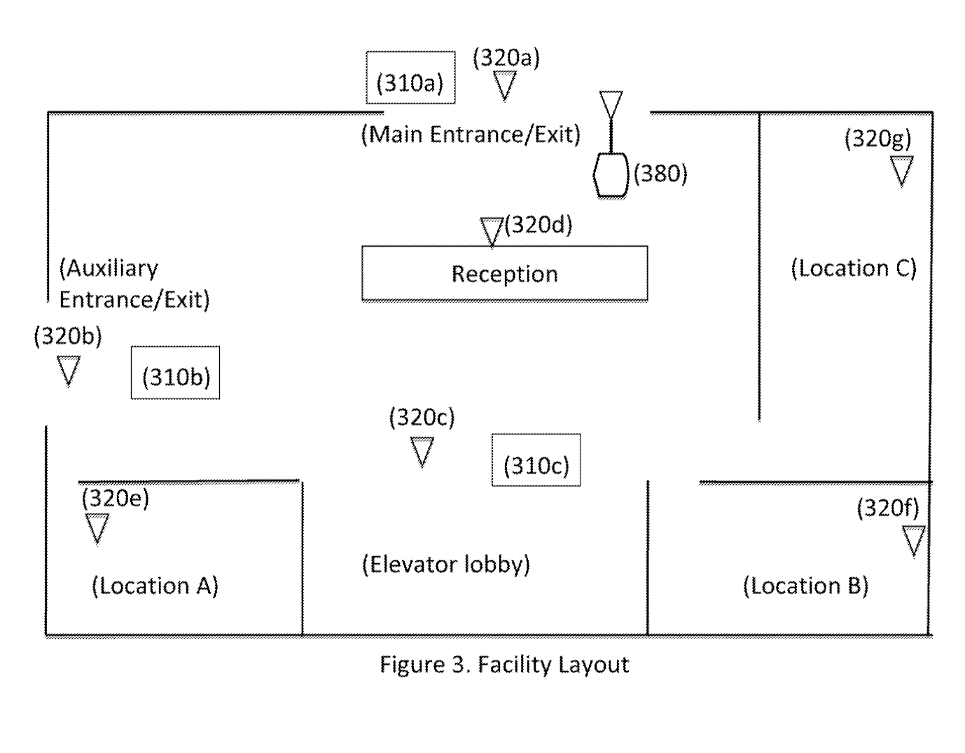

FIG. 3 is a diagram illustrating a layout of the VCAS local sensors 320a-320g (collectively “sensors 320”) in system 100 implemented in a facility. The sensors are placed in strategic locations on the facility property to permit facility employees to greet a customer carrying an identity device (e.g., 310a, 310b, or 310c (collectively “devices 310”)) within communication range of a sensor 320 as part of the customer recognition process of FIG. 4. As shown in FIG. 3, sensors 320a, 320b, 320c, 320d, 320e, 320f and 320g are placed respectively at the main entrance/exit, at the auxiliary entrance/exit, in the elevator lobby, at the reception desk, and in the other facility locations, including but not limited to, for example, the facility restaurant, gift shop, conference room, etc. The sensors 320 can each be configured with a power setting that limits the range of the sensor 320 to a predetermined distance. Sensors 320c through 320g located respectively in the different locations on the facility property can be set to different limited ranges, preferably a range between 10-15 feet. Sensors 320a and 320b located respectively at the main entrance/exit and the auxiliary entrance/exit can be set to farther ranges as desired. The ranges can be adjusted to minimize interference between the enabled devices and adjacent facilities.

FIG. 4 is a flowchart illustrating a customer recognition process using the customer recognition system 100 in accordance with an embodiment described herein. Customers can make a previous arrangement or reservation with the facility using any suitable means, e.g., via the Internet, telephone, etc. Preferably, the customer reservation is made on the facility's Website using a client computer 60 (FIG. 1). A customer reservation form on the Website would typically include the customer's input of billing information, visit information (e.g., check-in date, check-out date, room preference, etc.), and personal information (e.g., name, address, rewards number, etc.). If the customer reservation is made by a current account holder, most of this information would be available historically. In addition, the Website provides the customer with an explanation of the customer recognition process and the option of subscribing to the customer recognition program. It should be appreciated that other information (or less information) can be used as the billing, reservation and customer information. If the customer agrees to join the program, the customer is required to input data about a personal identity device, e.g., cellular telephone, smart phone, Blackberry™, or PDA. The input data preferably includes the telephone number of the identity device and the name associated with the account of the identity device. The telephone number and the associated name function to register the personal identity device as an identity device 10 for use in the system 100. Furthermore, the Website provides the customer with the option of providing an image for use in the system 100. In one embodiment, the image is a photograph taken using a web camera attached to a client computer 60. Alternatively, the customer can attach a previously taken photograph or mail in an image to the facility for input into the VCAS relational database 250 of the VCAS server 40.

The customer's visit information, personal information and billing information are stored in the IMS server 50 through the Internet 70 and the LAN 90. The IMS server 50 processes the received information in accordance with an existing facility workflow, e.g., stores the information in a facility database, generates a new reservation, and sends confirmations of the reservation to the customer. At step 400, the telephone number, the name associated with the registered identity device, and optionally an image are sent to the VCAS server 40 through the Internet 70 and the LAN 90. Advantageously, while making a reservation or other arrangement using the facility's Website, the only additional piece of information required by the disclosed customer recognition process is the telephone number of the personal identity device.

The VCAS server 40 creates a customer profile for the customer if a profile does not already exist in the VCAS relational database 250. At step 410, the account name, the telephone number of the identity device, and the image are stored in the VCAS relational database 250 as the customer profile in association with a unique device identification number. Preferably, the VCAS server 40 does not store duplicate information that can be retrieved from the IMS server 50. Alternatively, the VCAS server 40 may store a subset of duplicate customer information in association with the unique device identification number.

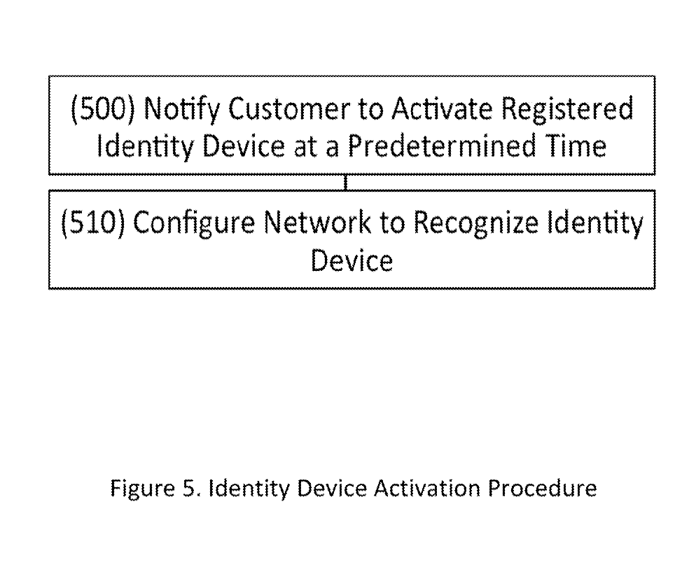

Step 420 is the identity device activation procedure illustrated in FIG. 5. Referring to FIG. 5, at step 500, the customer receives an email confirmation of the VCAS registration. In the email, the customer is instructed to activate the preferred communications feature, e.g., Bluetooth feature, of the registered identity device 10 at a predetermined time. Preferably, the customer is instructed to activate the registered identity device 10 prior to arrival at the facility. This instruction can also be communicated to the customer through other means independent of the email confirmation, e.g., a text message (SMS or MMS) or automated telephone call, reminding the customer to activate the registered identity device 10 before the planned arrival time.

At step S10, the LAN 90 is configured to recognize the identity device 10 registered with the facility's customer recognition program. In this example embodiment, during the recognition step, the LAN 90 is configured to establish a trusted pairing between the registered identity device 10 and any sensor 20 within communication range.

The foregoing describes a registration process using an identity device. If a customer does not have or wish to register an identity device, the reservation form on the facility Website allows the customer to request the facility to provide an identity device equipped with a transmitter. Upon receiving the request, the facility will register an identity device for the customer and send the identity device to the customer prior to the date of arrival at the facility.

Alternatively, the local sensors 20 (FIG. 1) are RFID responders and the identity devices 10 are facility-provided customer cards, each having a RFID token capable of communicating with the RFID responders when the customer card is within communication range. In this case, the RFID number is recorded in the VCAS relational database 250 as the unique device identification number. At step 400 (FIG. 4) of this example embodiment, the customer requests through a reservation form on a Website a customer card or, alternatively, a wristband or other RFID equipped device to be delivered to the customer prior to the visit. The VCAS server 40 (FIG. 1) at step 420 (FIG. 4) will activate the registered identity device associated with the customer on the day the customer is scheduled to arrive at the facility.

It should be appreciated that identity device registration can be achieved via any available network protocol, e.g., Ethernet, Bluetooth, WiFi and satellite communications, or out-of-band communications. The system 100 will collect the identifying information associated with the identity device 10 based on the available network protocol and register the identity device 10 for use with the LAN 90 of system 100.

Referring to FIGS. 3 and 4, a customer will arrive at the facility with an activated and registered identity device 310a. At step 430, when the identity device 310a is within range of the sensor 320a located at the main entrance/exit of the facility, the sensor 320a receives the signal containing only the unique device identification number from the identity device 310a registered with the customer. Sensor 320a passes the device identification number of device 310a to the VCAS server 40 (FIG. 1) via the VCAS router 30 for identification and authentication of the customer. The VCAS server 40 extracts the device identification number, using it as the search key in the VCAS relational database 250 to match the customer with his or her customer recognition program profile. Advantageously, since this embodiment sends only the unique device identification number across the LAN 90, the contents of the transmission can be sent unencrypted from the identity device 310a to the VCAS server 40 through the sensor 320a and router 30.

The VCAS server 40 is also able to detect the location of the sensor 320a and can adapt its data retrieval request to the VCAS relational database 250 and the IMS server 50. At step 440, the VCAS server 40 retrieves from the VCAS relational database 250 the stored customer profile data necessary to enable customer recognition, e.g., name and image, associated with the device identification number. The VCAS server 40 can also retrieve from the IMS server 50 additional data based on the fact that the source of the signal is sensor 320a located at the main entrance/exit of the facility. The additional data includes customer preference information associated with the customer (e.g., flight arrival information, length of stay, and facility rewards program status, etc.).

At step 450, the customer profile data and any additional data retrieved is transmitted via the sensor 320a that picked up the signal from the identity device 310a to all VCAS output devices 80 (FIG. 1) within communication range of the LAN 90. As shown in FIG. 3, a facility employee standing within communication range of the sensor 320a at the main entrance/exit of the facility receives the retrieved data on his VCAS output device 380, which is preferably a mobile output device, e.g., PDA. Alternatively, the retrieved data can be routed via a different sensor 320 in the LAN 90 or be transmitted to a workstation or other computing device connected to the LAN 90.

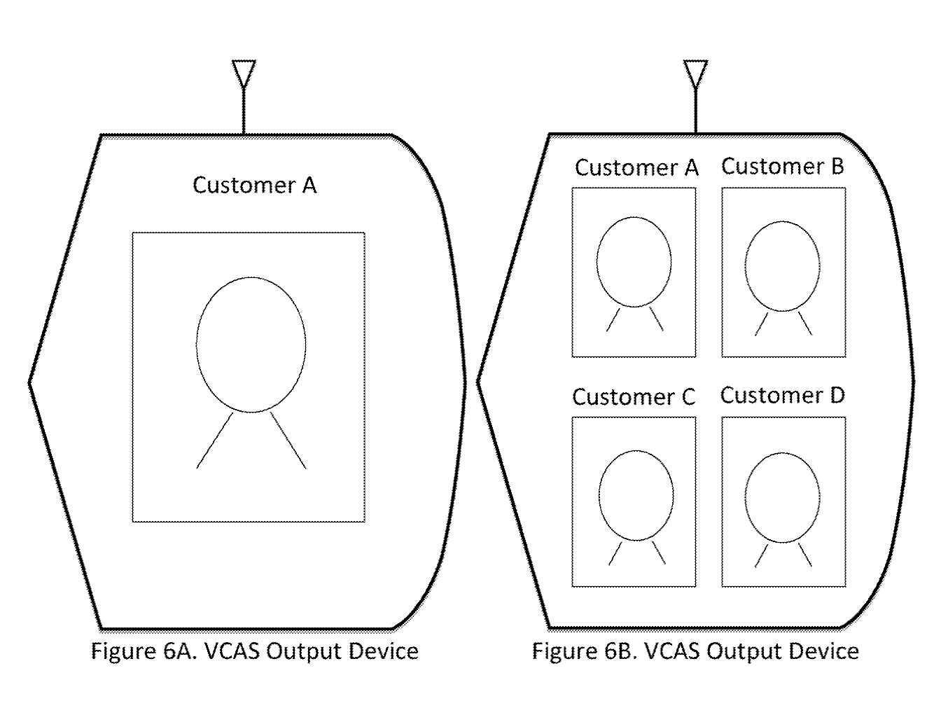

The VCAS output device 380 preferably is a PDA with a touch screen display capable of displaying the retrieved data, including the name and image of the customer profile data, as shown in FIG. 6A. Alternatively, the VCAS output device 380 can be a tablet, laptop, or stationary workstation. The facility employee makes a judgment as to whether the displayed image matches the customer. If the image matches the customer, the facility employee greets the customer by name. In this manner, facility employees are able to reliably track in real-time the arrival of registered customers at the facility.

In an alternative embodiment, the facility employee can change the status associated with the customer profile of the customer from “NOT GREETED” to “GREETED” by touching the screen display of the output device 380. The customer profile data is displayed on output device 380 with a dashed border when the customer is in the “NOT GREETED” state. After the facility employee greets the customer, the employee touches the screen display on the output device 380 to change the status associated with the customer profile from “NOT GREETED” to “GREETED.” The change in status is reflected on the output device 380 by displaying the customer profile data with a solid border instead of a dashed border. Alternatively, the status change can be illustrated by a change in the background color of the display of output device 380. At step 460, the VCAS server 40 receives and stores an acknowledgement status associated with the customer from the sensor 320a via router 30. The status of whether the customer has been greeted is stored in the VCAS relational database 250 as a field associated with the device identification number.

Alternatively, if multiple customers are within communication range of sensor 320a, the device identification numbers of the multiple customers are sent to the VCAS server 40 to retrieve the customer profile data and any other data associated with each device identification number. The output device 380 will display all of the customer profiles simultaneously to facility employee using a split screen as shown in FIG. 6B. In this way, the facility employee is able to greet multiple customers, e.g., an entire family, in real-time. Likewise, the facility employee can update the status of each customer by touching the respective part of the output device 380 displaying the data associated with the respective customer.

If the device identification number is not found in the VCAS relational database 250 at step 440, an error message is sent back to the sensor 320a via the VCAS router 30 at step 450. The facility employee is notified of the error by displaying the error message on the output device 380. By knowing that a customer is not registered with the customer recognition program, the facility employee can ask the customer whether he is staying at the facility and whether he wishes to enroll in the facility's customer recognition program.

Upon receiving acknowledgment that the customer has been greeted by the employee, the VCAS server 40 updates the status of the customer profile associated with customer and notifies the IMS server 50 of the status change at step 470. In this way, the facility management is notified that a customer has entered the facility property and subsequent facility operations in accordance with the facility's existing workflow can take place. For example, the status change can function as a notification that the customer needs to be checked-in or require a specialized service.

The above description of steps 430 through step 470 illustrates an example of the use of the customer recognition system 100 when the customer initially arrives at the main entrance/exit of the facility. In another example, the process can be used to greet a customer at a different facility location, e.g., the facility restaurant, gift shop, conference room, etc. In an example where the facility location A (FIG. 3) is the facility restaurant, the customer at step 430 will arrive at the facility location A carrying the identity device 310. At step 430, when the identity device 310 is within communications range of the sensor 320e located near the entrance of the facility location A, the sensor 320e receives the signal containing the device identification number from the identity device 310. The device identification number is passed to the VCAS server 40 via the sensor 320e and the VCAS router 30. At step 440, the VCAS server 40 retrieves from the VCAS relational database 250 the stored customer profile data associated with the device identification number. Additional data such as the special needs, food allergies and preferred table for customer can be retrieved from the IMS server 50 or the VCAS relational database 250 based on the fact that the source of the signal is sensor 320e. The retrieved data is sent back to a VCAS output device 80 via the sensor 320e. At step 450, a facility employee carrying a preferably mobile VCAS output device 80 in communications range of the sensor 320e will see on the display of the output device 80 the retrieved information for the customer. The facility employee is able to greet the customer by name, and address the customer's needs appropriately.

The customer recognition process, and in particular steps 430 to steps 470, can operate in numerous other situations to enable any facility employee carrying a preferably mobile VCAS output device 80 to greet a customer carrying a registered identity device 10 in communications range of a sensor 20. The customer recognition process and system enables facility management to provide better customer service and implement more efficient workflow processes by personally greeting each customer by name and automatically being informed of additional information such as customer preferences based on the actual location of the customer.

If a customer loses the identity device 10 within communication range of a sensor 20, the VCAS server 40 is able to detect the location of the sensor 20 that received the last signal containing the unique device identification number associated with the device 10. Facility employees can find the lost device 10 based on the location of the sensor 20 and return the device 10 to the customer.

Referring to FIG. 4, at step 480, the identity devices 310 can be deactivated when the customer checks-out of the facility. The deactivation can be implemented differently based on the type of identity device 310. The facility may un-pair the device 310a from the LAN 90. After the VCAS server 40 deactivates the identity device 310a, the device 310a will no longer be able to establish a trusted pairing with any sensor 320. Alternatively, when the system 100 uses customer cards with RFID tokens, the deactivation step includes dropping the customer card in a check-out box equipped with a RFID responder. The check-out boxes are located in designated areas at the facility, including near the main entrance/exit of the facility building. When the customer card is deposited into a check-out box, the RFID responder detects a radio signal containing a unique identification number from the customer card and sends this signal to the VCAS server 40. The VCAS server 40 updates the status of the customer card associated with the identification number to deactivated. Thus, the VCAS server 40 is able to activate and deactivate the use of identity devices 310 at any time.

The customer recognition system provides a service that expands on the standard business practice of recognizing and knowing a customer. With the ability to read electronic signals offered by persons carrying compatible devices and carried over public communications channels using standard communications protocols, the disclosed embodiments of the customer recognition system provides customer centric businesses with the ability to deliver their products and services faster and more efficiently. In the hospitality industry, for example, the disclosed embodiments of the customer recognition system offers facility management the capability to implement improved security procedures. Facility employees are able to quickly identify registered customers on the property by name and image at predefined locations. Unidentified customers can be invited to register with the facility customer recognition program. The disclosed embodiments further help increase the profits of the facility's business by equipping employees with useful information such as, for example, suggested products and services when the customer is greeted at the facility shops. The ability to recognize customers seamlessly and quickly is instrumental to providing exceptional customer service.

The customer recognition system can be deployed in any venue where personnel accountability is desired such as, for example, airline employees at the airport, accounting of factory or dock workers during shift changes, staff at a secured facility, and visitors at a hospital or doctor's office. Disclosed embodiments of the customer recognition method can be used to enhance the workflow at each of these venues to direct people in an organized manner.

The functionality of the VCAS server 40 can be embodied as software code or a computer program stored on a computer-readable medium such as a CD, DVD, or any other storage medium. When the software code or computer program is executed on a computer, the computer operates as the VCAS server 40 in accordance with FIG. 4.

The foregoing merely illustrates the principles of the disclosed embodiments. For example, although the VCAS server 40 is described as independent of the IMS server 50, it is possible for alternative embodiments to have a single server that functions as both the VCAS server 40 and the IMS server 50. The foregoing assumes that each individual customer will register a single wireless device for a particular facility reservation. Alternatively, multiple wireless devices can be associated with a common account. The primary account holder can register devices for family members or a corporate account can be associated with the transmitters of the employees. Still other alternative embodiments can use a facility provided identification number to uniquely identify an identity device 10 instead of a device identification number.

What is claimed as new and desired to be protected by Letters Patent of the United States is:

1. A customer recognition method carried out by a customer recognition system having an acknowledgment server with a profile database, the customer recognition method comprising the steps of:
activating an identity device of a customer with the customer recognition system;
receiving identification information indicating the presence of the identity device from a sensor located at a predetermined location;
retrieving customer profile data from the profile database based on the received identification information;
sending the customer profile data to the sensor; and
receiving an acknowledgement status relating to the customer.

2. The customer recognition method of claim 1, wherein the activating step comprises:
notifying the customer to activate the identity device at a predetermined time; and
configuring the customer recognition system to recognize the identity device.

3. The customer recognition method of claim 2, wherein the identity device and the sensor are capable of communicating with each other using Bluetooth wireless technology and the configuring step comprises establishing a trusted pairing between the identity device and the sensor when they are within communication range.

4. The customer recognition method of claim 1, wherein the identification information is received from the sensor in unencrypted form.

5. The customer recognition method of claim 1, wherein the identification information consists of a device identification number.

6. The customer recognition method of claim 1, wherein identification information related to a plurality of identity devices is received from the sensor and the customer profile data associated with the identification information for each of the plurality of identity devices is sent to the sensor.

7. The customer recognition method of claim 1, further comprising:
sending the customer profile data to an output device within communication range of the sensor; and
displaying the customer profile data on a display of the output device.

8. The customer recognition method of claim 7, wherein the displaying step comprises displaying on the display of the output device a name and a photo associated with the customer.

9. The customer recognition method of claim 7, wherein the displaying step comprises displaying on the display of the output device a plurality of customer profile data.

10. The customer recognition method of claim 1, further comprising changing a status associated with the customer profile data in the profile database based on the acknowledgement status.

11. A computer-readable medium encoded with a customer recognition program for causing a computer to perform:
storing customer profile data and identity device data related to a customer in a profile database;
associating a unique device identifier with the identity device data and the customer profile data in the profile database;
receiving the unique device identifier from a sensor when an identity device associated with the identity device data is within communication range of the sensor;
retrieving the customer profile data associated with the unique device identifier from the profile database;
sending the customer profile data to one or more output devices within communication range of the sensor; and
storing an acknowledgement status sent by the one or more output devices relating to the customer.

12. The computer-readable medium of claim 11, further comprising:
receiving a customer request to subscribe the identity device with the customer recognition program; and
registering a name and a telephone number associated with the identity device as part of the identity device data in the profile database.

13. The computer-readable medium of claim 11, further comprising storing additional data including customer preference data related to the customer in the profile database.

14. The computer-readable medium of claim 11, further comprising displaying the customer profile data on a display of the output device.

15. The computer-readable medium of claim 14, wherein the displaying step comprises displaying on the display of the output device a plurality of customer profile data.

16. The computer-readable medium of claim 11, further comprising changing a status associated with the customer profile data in the profile database based on the acknowledgement status.

17. A customer recognition system comprising:
a server comprising a customer profile database for storing customer profile data and identity device data in association with a unique device identifier, the server being configured to retrieve respective customer profile data and identity device data from the database based on the unique device identifier;
at least one sensor configured to communicate with an identity device and the server; the sensor receives the unique device identifier associated with the identity device when the identity device is within communication range;
one or more output devices configured to communicate with the sensor, a respective output device receives customer profile data based on the unique device identifier associated with the identity device when the respective output device is within communication range of the sensor; and
a network providing communication between the server, the at least one sensor, the one or more output devices and the identity device.

18. The system of claim 17, wherein the output devices each have a user interface for displaying the customer profile data.

19. The system of claim 17, wherein each output device is configured to receive an acknowledgement status related to the identity device.

20. The system of claim 19, wherein each output device is configured to send the acknowledgement status to the server through the network.
